(19) United States
(12) Patent Application Publication
(10) Pub. No.: US 2025/0239844 A1
(43) Pub. Date: Jul. 24, 2025

(54) Clamp Holder For Attaching Components To Structural Components Of A Vehicle

(71) Applicant: Elbe Flugzeugwerke GmbH, Dresden (DE)

(72) Inventors: Eric Grande, Dresden (DE); Andree Hübner, Dresden (DE)

(73) Assignee: Elbe Flugzeugwerke GmbH, Dresden (DE)

(21) Appl. No.: 19/033,050

(22) Filed: Jan. 21, 2025

(30) Foreign Application Priority Data
Jan. 22, 2024 (DE) 102024101769.4

(51) Int. Cl. H02G 3/00; B64C 1/06

(52) U.S. Cl. CPC H02G 3/263; B64C 1/064

(57) ABSTRACT

A clamp holder (10) for attaching components to a structural component (110) of a vehicle (100) is disclosed. The clamp holder (10) comprises a first clamp member (11), a second clamp member (12), and a component attachment portion (13). An inner side (14) of the first clamp member (11) is configured to correspond to a shape of a first side (111) of the structural component (110). An inner side (15) of the second clamp member (12) is designed to correspond to a shape of a second side (112) of the structural component (110), which is opposite the first side (111). The first clamp member (11) and the second clamp member (12) are connectable to each other so that the clamp holder (10) engages the structural component (110) with the inner side (14) of the first clamp member (11) and with the inner side (15) of the second clamp member (12), so that the clamp holder (10) surrounds the structural component (110) at least in sections when the clamp holder (10) is attached to the structural component (110). The component attachment portion (13) is provided on the first clamp member (11) and is designed to fasten a component to the clamp holder (10). Further disclosed is a vehicle (100) having a corresponding clamp holder (10).

### TECHNICAL FIELD

The present disclosure relates to a clamp holder for attaching components to a structural component of a vehicle and to a vehicle having a corresponding clamp holder.

### TECHNICAL BACKGROUND

In airplanes, countless small holders for attaching components, especially cables, lines and the like, are attached to the structural components of the airplane (i.e. stringers and frames) throughout the aircraft. These holders are usually riveted to the corresponding structural components in laborious manual work. For example, holders are known that are pushed through corresponding holes in the structural components in the form of a rivet and then riveted. Cable harnesses, fluid lines, insulation and other components can then be attached to these holders.

To attach the brackets described above, holes must therefore be drilled through the corresponding structural components, which can weaken the structural integrity of the structural components and thus the primary structure of the aircraft. In addition, the holder positions cannot be varied during assembly due to the holes required in the structural components. However, it is possible that such holders may have to be positioned slightly differently, for example when mounting cables, due to space constraints or other reasons. In the case of rivet holders that are fitted in rivet holes, it is then necessary to drill holes again in order to be able to position the holder at a different location.

Known rivet holders are therefore very time-consuming to install and can weaken the structural integrity due to its working principle. In addition, the long installation times have a negative impact on occupational safety, as the corresponding technician may have to stand on ladders for long periods and carry out complicated work steps.

Another problem with such rivet holders is that they are usually made of metallic materials such as titanium. Due to the large number of holders required, this leads to a considerable increase in weight for the aircraft. In aviation, however, there is always a general desire to reduce the weight of the aircraft.

### DESCRIPTION

Accordingly, it can be regarded as an objective of the invention to create a simple, quick and flexible mounting device for attaching components to structural components of vehicles, which at the same time reduces the weight.

This objective is solved by the subject-matter of the independent claims. Further embodiments result from the dependent claims and in the following description.

According to a first aspect, a clamp holder for attaching components to a structural component of a vehicle is disclosed. The clamp holder comprises a first clamp member, a second clamp member, and a component attachment portion. An inner side of the first clamp member is configured to correspond to a shape of a first side of the structural component. An inner side of the second clamp member is configured to correspond to a shape of a second side of the structural component, which is opposite to the first side. The first clamp member and the second clamp member are connectable to each other so that the clamp holder engages the structural component with the inner side of the first clamp member and with the inner side of the second clamp member, such that the clamp holder surrounds the structural component at least in sections when the clamp holder is attached to the structural component. The component attachment portion is provided on the first clamp member and is designed to fasten a component to the clamp holder.

The structural component can be, for example, a stringer or a frame of an aircraft. Although the clamp holder is described herein primarily in relation to aircraft and primarily in relation to stringers, it should be noted that the clamp holder can in principle also be used in any other type of vehicle, such as trains, motor vehicles, buses, streetcars or any other vehicle. It is also conceivable that the clamp holder could be used in buildings, for example.

Components to be fastened can be electrical cables, pipes, shafts, ducts or any other component.

The first clamp member and the second clamp member are essentially halves of the clamp holder, the inner sides of which are designed together as a negative shape of the structural components to which the clamp holder is to be attached. In other words, an inner side of one half of the clamp holder, i.e. of the first clamp member, for example, is shaped to correspond at least substantially (in particular form-fitting) with one side of the structural component. This is essentially because, according to certain embodiments, for example, additional adhesive coatings can be provided on the inner sides of the clamp members, and the inner sides can therefore also be manufactured slightly larger. Manufacturing tolerances must of course also be considered. The inner side of the other half of the clamp holder, i.e. the second clamp member, is then formed in the same way, essentially corresponding (in particular form-fitting) with the other side of the structural component. It should be noted that the clamp holder can be attached in particular to an outer edge of the structural components, so that the first clamp member and the second clamp member can be attached to opposite sides of the structural component in such a way that they rest against opposite sides in a form-fitting manner and can be connected to one another, for example, via a corresponding protrusion on the outer edge of the structural component. This is meant by the first clamp member and the second clamp member surrounding the structural component at least in sections and engaging them.

Using the example of a stringer as a structural component, which is an elongated component that runs along a longitudinal axis of an aircraft and whose cross-section is essentially hat-shaped, the crown of the corresponding hat profile can rest against an inner wall of an aircraft fuselage and can be attached to it. In the circumferential direction of the aircraft fuselage in a cross-section, the correspondingly curved brims of the hat profile then protrude. The clamp holder can be attached to these brims of the hat profile, for example, by the first clamp member resting in a form-fitting manner against the side of the corresponding brim of the stringer facing the aircraft fuselage. The second clamp member is then form-fittingly attached to the side of the corresponding brim facing away from the aircraft fuselage. It should be noted that this sequence is exemplary. The positions or roles of the first clamp member and the second clamp member can also be reversed. The first clamp member and the second clamp member therefore clamp the respective brim between them, so to speak, and protrude from the edge of the brim. The parts of the clamp members protruding at the edge of the brim can then be connected to each other in any suitable manner, for example via a clamp screw connection, as described below, or also with a correspondingly strong spring, even if spring clamping is not the preferred embodiment due to the fatigue of the spring. It is also conceivable that the corresponding protruding parts of the first clamp member and the second clamp member have a through hole through which any suitable type of connecting element, such as screws, rivets, etc., can be inserted and fastened.

Overall, the disclosed clamp holder eliminates the need for rivet holes (or other holes) in the structural component itself. In addition, the clamp holder can be flexibly attached at any point of the structural components without being fixed to pre-planned fastening positions.

The component attachment portion may be any suitable attachment portion that allows attachment of desired components to the clamp holder. For example, the component attachment portion may be a through hole, a tab, a clip, or any other suitable attachment portion for the intended use. It should also be noted that the component attachment portion does not necessarily have to be provided on the first clamp member but can also be provided on the second clamp member. It is also conceivable to provide (identical or different) component attachment portions on both clamp members.

According to one embodiment, the component attachment portion is configured to receive and hold a cable as a component.

For this purpose, the component attachment portion can, for example, be a through hole that extends through at least one of the first and second clamp members. The cable can then be guided through such a through-hole and fastened with the clamp holder. However, it is also conceivable that the component attachment portion is designed as a clip, groove or similar.

According to a further embodiment, the component attachment portion is a through hole in the first clamp member configured to receive an elongate component.

Such an elongated component can, for example, be a cable, a pipe, a duct or a similar elongated component, which can be inserted through a corresponding through-hole. For example, it is conceivable to attach a clamp holder to each successive stringer of an aircraft at the same circumferential position so that the corresponding through holes are aligned with each other. Cables, for example, can then be laid along the longitudinal axis of an aircraft through the aligned through-holes.

Preferably, for example, in a clamp holder for a stringer, the through hole is arranged in the first clamp member in such a way that it extends in the hat profile formed by a brim of the stringer in cross-section. This allows, for example, a cable, line or duct to be laid in the brim of the stringer along the longitudinal axis of the aircraft to save space.

According to a further embodiment, the through hole extends along a longitudinal direction of the structural component when the clamp holder is attached to the structural component.

In particular, the through hole can run parallel to the longitudinal axis of the structural component, for example in the case of a stringer within a channel formed by the hat profile (in cross-section), which runs along the longitudinal axis of the stringer. However, this is only one example. In principle, the clamp holder can also be used for any other structural component that does not necessarily comprise a hat profile in cross-section. The through hole can then be arranged and aligned as required.

According to a further embodiment, the first clamp member and the second clamp member can be connected to each other by means of a clamp screw connection.

Such a clamp screw connection can be made, for example, in the section of the first and second clamp member protruding from the edge of the structural component. The strength of such a compression fitting can be easily adapted to the respective requirements, for example with a torque wrench, and enables particularly easy assembly of the clamp holder. For example, a clamp screw connection can be made with a self-locking screw, a screw/nut combination or also with available screws that can be inserted from one side. For example, it is also conceivable to insert a screw bush with an internal thread from one side, which, on the side opposite the insertion point, is designed to expand when a screw with an external thread is inserted into the bush, thus pressing the first clamp member and the second clamp member together (similar to a rivet). For this, the end opposite the insertion side can, for example, also have a corresponding circumferential flange, which then presses against the second clamp member when a screw with an external thread is inserted from the side of the first clamp member (which in this example corresponds to the insertion side). This allows a clamp screw connection to be achieved from only one side.

In principle, however, this is only one example and any other suitable type of clamp screw connection can be used.

According to a further embodiment, the first clamp member and/or the second clamp member comprises an adhesive coating on a side facing the structural component in the installed state.

The adhesive coating is generally to be understood as an anti-slip coating which, for example, prevents the clamp holder from slipping along a longitudinal axis of the structural component or generally away from the intended position on the structural component. The adhesive coating can, for example, be an adhesive coating, such as a corresponding coating of an adhesive, but also, for example, a thin rubber pad or similar, which provides a certain resistance to displacement.

According to a further embodiment, the first clamp member and/or the second clamp member is an element manufactured by 3D printing.

In particular, 3D printing enables fast and cost-effective production with plenty of design freedom when shaping the clamp holder. In addition, such a clamp holder is made of lightweight plastic and thus contributes to weight reduction. This type of production is particularly advantageous for applications in which the clamp holder does not have to carry much weight, such as a cable holder. Furthermore, production using 3D printing can be particularly advantageous for special shapes or for small series or individual parts for which production using shaping or other processes, for example, is uneconomical, as 3D printing eliminates the need for expensive production facilities.

According to a further embodiment, the first clamp member and/or the second clamp member are manufactured using a shaping process.

For example, such shaping processes can include injection molding processes (or other casting processes), whereby a molten material is injected into a shaping cavity of a tool, compressed under pressure and cross-linked or cooled and then ejected as a molded part.

In such injection molding processes, for example, plastic injection molding processes are conceivable in which the molten material is a molten plastic.

However, other injection molding processes, such as metal injection molding (MIM), are also conceivable, particularly for applications in which increased strength of the clamp holder is desired, whereby a fine metal powder is mixed with a binder and then injected into shape in the usual injection molding manner. The binder can then be removed from the injection-molded parts (for example in an acetone bath) and the injection-molded parts can then be sintered at a high temperature in an oven. The result is a purely metallic end product (in this case the clamp members) that combines the mechanical advantages of sintered components with the wide range of shapes offered by injection molding. Another alternative is ceramic injection moulding (CIM), for example, which is similar to the MIM process in terms of process technology, but is optimized for the production of ceramic components.

In principle, however, the clamp members can also be manufactured using any other suitable primary forming process or, for example, by extrusion or any other suitable process.

Shaping processes such as injection molding (e.g. plastic injection molding, MIM, CIM and other suitable processes) are particularly advantageous for the series production of large quantities.

According to a further embodiment, the clamp holder is designed to be attached to a stringer or a frame of an aircraft.

In particular, the clamp holder or its first and second clamp members (and their inner sides) can be designed as a negative shape of the contour of such a stringer or frame. This allows components such as cables, lines or ducts to be laid along the longitudinal axis of the aircraft and attached to the primary structure of the aircraft in a simple and flexible manner.

According to a second aspect, a vehicle is disclosed. The vehicle comprises a vehicle shell, at least one structural component, and at least one clamp holder according to one of the described embodiments. The at least one clamp holder is attached to one of the at least one structural component and attaches a component to the structural component.

The clamp holder can be designed according to any of the previously described embodiments. The vehicle may, for example, be an airplane, a streetcar, a bus, a train, a motor vehicle, or any other vehicle.

According to one embodiment, the vehicle is an aircraft. The at least one structural component is a stringer or a frame of the aircraft.

In summary, the disclosed clamp holder provides a simple means of attaching components such as, in particular, cables, conduits, shafts and the like, but also any other suitable component, directly to a structural component of a vehicle. The clamp holder does not require any holes to be drilled in the structural component and therefore avoids weakening the structural integrity of the primary structure. In addition, the fastening principle used can significantly reduce assembly times, particularly as there is no need for the time-consuming drilling of holes and riveting of brackets. Last but not least, occupational safety is also increased, as installers do not have to stand on ladders for as long and also have to carry out fewer complicated work steps.

### BRIEF DESCRIPTION OF THE FIGURES

In the following, exemplary embodiments are discussed in more detail with respect to the enclosed drawings. The illustrations are schematic and not to scale. Identical reference signs refer to identical or similar elements. The figures show:

FIG. 1A schematic view of a clamp holder on the example of a clamp holder for a stringer in an airplane in a first perspective.

FIG. 2A schematic view of the clamp holder from FIG. 1 in a second perspective.

FIG. 3A cross-sectional view of the clamp holder of FIGS. 1 and 2, which is mounted on a stringer.

FIG. 4 An aircraft as an exemplary vehicle comprising the clamp holder disclosed herein on a structural component.

### DETAILED DESCRIPTION

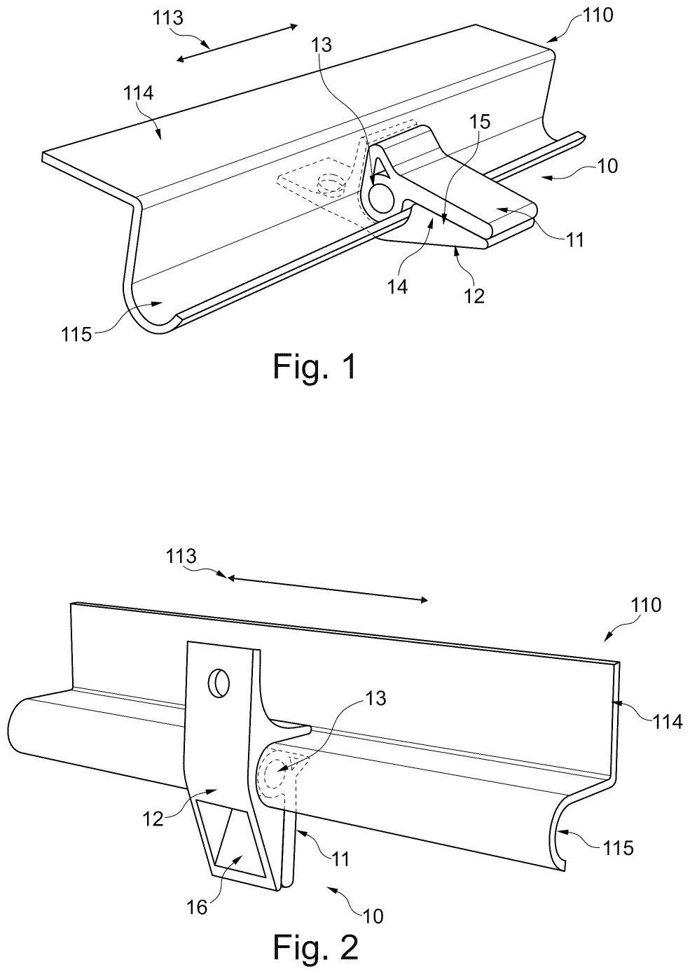

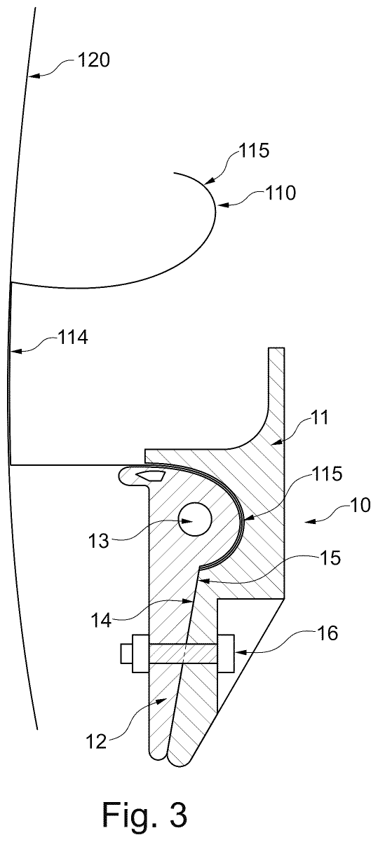

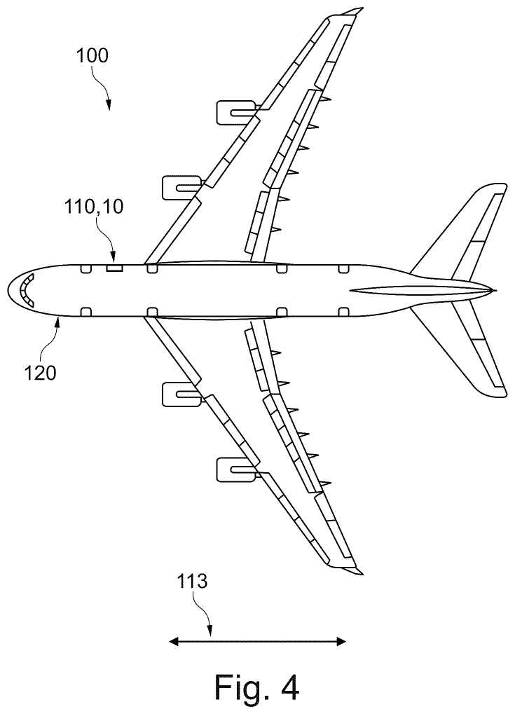

FIGS. 1 to 3 show an exemplary clamp holder 10, which is attached to a structural component 110 of a vehicle 100 (not shown, see FIG. 4), in various views. FIGS. 1 and 2 show perspective views from the front and rear. FIG. 3 shows a cross-sectional view of the clamp holder 10. In the following, FIGS. 1 to 3 are described together, as they show the same configuration only in different views.

In FIGS. 1 to 3, the clamp holder 10 is attached to a stringer 110 (as a structural component 110) of an aircraft 100 (as a vehicle 100). The stringer 110 comprises a hat-shaped cross-section with a crown 114 and two brims 115 (only one of which is shown in FIGS. 1 and 2). In FIG. 3, the stringer 110 is in contact with an aircraft fuselage 120.

The clamp holder 10 comprises a first clamp member 11 and a second clamp member 12. The first clamp member 11 has an inner side 14 and the second clamp member 12 has an inner side 15. The inner sides 14, 15 are each formed in a corresponding manner, in particular in a form-fitting manner, with a corresponding side of one of the brims 115 to which the clip holder 10 is attached. In other words, the inner side 14 of the first clamp member 11 is formed in a form-fitting manner with a side of the corresponding brim 115 facing the aircraft cabin and the inner side 15 of the second clamp member 12 is formed in a form-fitting manner with a side of the corresponding brim 115 facing away from the aircraft cabin and towards the aircraft fuselage.

Both the first clamp member 11 and the second clamp member 12 also comprise a protrusion (in FIG. 3, the section which protrudes downwards from the brim 115). The protrusions of the first clamp member 11 and the second clamp member 12 are also designed to form a positive fit with each other. A clamp screw connection 16, designed as a screw and nut in the example shown, clamps the first clamp member 11 and the second clamp member 12 together, so that the clamp holder 10 between the first clamp member 11 and the second clamp member 12 surrounds the stringer 110 in sections (i.e. on the brim 115) and engages in the stringer 110. The clamp screw connection 16 thus provides a good attachment of the clamp holder 10 to the stringer 110. It should be noted that the clamp screw connection 16 may also be configured in any other suitable manner as described further hereinabove, or that the first clamp member 11 and the second clamp member 12 may also be connected together in any other suitable manner such that the clamp holder 10 engages the stringer 110 (or more generally the structural component 110; which may also be, for example, a frame or structural component of a vehicle other than an aircraft 100). Since both the first clamp member 11 and the second clamp member are designed to be form-fitting both to the stringer 110 and to each other, the clamp holder 10 cannot twist relative to the stringer.

The clamp holder 10 also comprises a component attachment portion 13, which in the example shown is configured as a through hole 13 which extends in the channel formed by the brim 115 along the longitudinal axis 113 of the structural component 10, which in the example shown (as the structural component 110 is a stringer 110) coincides with a longitudinal axis 113 of the aircraft (see FIG. 4). For example, a cable or conduit can be received through the through hole 13 so that the clamp holder 10 serves, for example, as a cable holder for attaching cables to the primary structure of the aircraft.

It should be noted that the through hole 13 is only one example of a component attachment portion 13. The component attachment portion 13 can in principle also be designed in any other suitable manner, as already described hereinabove. In addition, the component attachment portion 13 may also be provided on the second clamp member 12 or both the first clamp member 11 and the second clamp member 12 may comprise a corresponding component attachment portion. All combinations are possible, even with more than one component attachment portion 13 on one of the clamp members 11, 12, as long as the shape of the clamp members 11, 12 is adapted accordingly.

Preferably, the clamp holder 10 is a part obtained by 3D printing or a plastic part manufactured in some other way. This can reduce the weight of the aircraft 100 (or a vehicle in general). However, the clamp holder 10 may also be manufactured in any other suitable manner, for example by injection molding, as a sintered part, as a forged part, as a molded part, or in any other manner.

The disclosed clamp holder 10 eliminates the need for rivet holes in the structural components 110, as is the case with prior art rivet holders, thereby also reducing assembly times.

FIG. 4 shows an example of an aircraft 100 as a vehicle 100, in which several stringers and frames or in general structural components 110 run (not shown in FIG. 4). The aircraft 100 comprises an aircraft fuselage 120. On at least one of the structural components 110, there is a clamp holder 10 as described above (indicated schematically as a box), for example to hold cables or other components and bind them to the primary structure of the aircraft 100.

The clamp holder 10 of FIGS. 1 to 3 can be designed in any of the ways described above. In addition, the clamp holder 10 can also be designed for structural components in other types of vehicles or even in houses.

In addition, it should be noted that “comprising” or “comprising” does not exclude other elements or steps and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

### REFERENCE LIST

10 clamp holder
11 first clamp member
12 second clamp member
13 component fastening portion, e.g. through hole
14 inner side of the first clamp member
15 inner side of the second clamp member
16 clamp screw connection
100 vehicle
110 structural component, e.g. stringer or frame
111 first side of the structural component
112 second side of the structural component
113 longitudinal direction of the structural component
114 crown
115 brim
120 vehicle fuselage, aircraft fuselage

1. A clamp holder (10) for securing components to a structural component (110) of a vehicle (100), the clamp holder (10) comprising:
a first clamp member (11);
a second clamp member (12); and
a component attachment portion (13);
wherein an inner side (14) of the first clamp member (11) is designed to correspond to a shape of a first side (111) of the structural component (110);
wherein an inner side (15) of the second clamp member (12) is designed to correspond to a shape of a second side (112) of the structural component (110), which lies opposite the first side (111);
wherein the first clamp member (11) and the second clamp member (12) are connectable to each other so that the clamp holder (10) engages the structural component (110) with the inner side (14) of the first clamp member (11) and with the inner side (15) of the second clamp member (12), such that the clamp holder (10) surrounds the structural component (110) at least in sections when the clamp holder (10) is attached to the structural component (110); and
wherein the component attachment portion (13) is provided on the first clamp member (11) and is designed to fasten a component to the clamp holder (10).

2. The clamp holder (10) of claim 1, wherein the component attachment portion (13) is configured to receive and hold a cable as a component.

3. The clamp holder (10) of any one of the preceding claims, wherein the component attachment portion (13) is a through hole (13) in the first clamp member (11) configured to receive an elongate component.

4. The clamp holder (10) of claim 3, wherein the through hole (13) extends along a longitudinal direction (113) of the structural component (110) when the clamp holder (10) is attached to the structural component (110).

5. The clamp holder (10) of any one of the preceding claims, wherein the first clamp member (11) and the second clamp member (12) are connectable to each another via a clamp screw connection.

6. The clamp holder (10) of any one of the preceding claims, wherein the first clamp member (11) and/or the second clamp member (12) comprises an adhesive coating on the inner side (14, 15) facing the structural component (110) in the installed state.

7. The clamp holder (10) of any one of the preceding claims, wherein the first clamp member (11) and/or the second clamp member (12) is an element manufactured by 3D printing.

8. The clamp holder (10) of any one of the preceding claims, wherein the clamp holder (10) is designed to be attached to a stringer (110) or a frame of an aircraft (100).

9. A vehicle (100), comprising:
a vehicle shell (120);
at least one structural component (110); and
at least one clamp holder (10) of any one of the preceding claims;
wherein the at least one clamp holder (10) is attached to one of the at least one structural components (110) and secures a component to the structural component (110).

10. The vehicle (100) of claim 9, wherein the vehicle (100) is an aircraft (100); and
wherein the at least one structural component (110) is a stringer (110) or a frame of the aircraft (100).
